(19) United States
(12) Patent Application Publication
(10) Pub. No.: US 2024/0128843 A1
(43) Pub. Date: Apr. 18, 2024

(54) ROTOR FOR AN ELECTRIC MACHINE

(71) Applicant: ANDRITZ HYDRO GMBH, Wien (AT)

(72) Inventors: Alexander JOHN, Graz (AT); Christoph WEINBERGER, Fladnitz an der Teichalm (AT); Siegfried STADLHOFER, Semriach (AT)

(73) Assignee: ANDRITZ HYDRO GmbH, Wien (AT)

(21) Appl. No.: 18/278,965

(22) PCT Filed: Feb. 8, 2022
(86) PCT No.: PCT/AT2022/060037

§ 371 Date: Aug. 25, 2023

(30) Foreign Application Priority Data
Apr. 27, 2021 (AT) A 50315/2021

(51) Int. Cl. H02K 17/16

(52) U.S. Cl. CPC H02K 17/168

(57) ABSTRACT

A rotor for an electric machine, including a laminated core with slots in which bottom bars and top bars are arranged to in an axial direction beyond the laminated core to form a winding overhang. A bottom bar of one slot is respectively connected to a top bar of another slot in the winding overhang and, in a plan view, bottom bars and top bars cross axially outside the laminated core at crossing points and gaps remain between the crossing points. A support device has a retaining body arranged radially inside the winding overhang and at least one clip having two legs and a crosspiece. The is connected to both the retaining body and to a top bar to radially support the top bar by the retaining body. To ensure a robust stabilization of the winding overhang the legs protrude through two gaps adjacent to different top bars.

The invention relates to a rotor for an electric machine, comprising a laminated core with slots in which bottom bars and top bars are arranged, which bars extend in an axial direction beyond the laminated core to form a winding overhang, wherein a bottom bar of one slot is respectively connected to a top bar of another slot in the winding overhang and, in a plan view, bottom bars and top bars cross axially outside the laminated core at crossing points and gaps remain between the crossing points, wherein a support device is provided which has a retaining body arranged radially inside the winding overhang and at least one clip having two legs and a crosspiece, the clip being connected to both the retaining body and to a top bar in order to radially support the top bar by means of the retaining body.

From the prior art, rotors of the type named at the outset have become known which, for example, are used in asynchronous machines in pumped-storage power plants, wherein the asynchronous machines are used both as a motor and as a generator.

During operation, centrifugal forces act on the rotor, and in particular on the top bars and bottom bars, due to a rotation of the rotor about a rotor axis. The top bars and the bottom bars are typically supported against said centrifugal forces in the region of the laminated core by slot wedges. Outside the laminated core, in the winding overhang, this is not possible, which is why, from document U.S. Pat. No. 5,606,212 A in particular, a support device has become known which comprises a clip that is mounted, on the one hand, radially inside the winding overhang on a peripheral ring disk and, on the other hand, grips a top bar and a bottom bar in order to support said top bar and the bottom bar against centrifugal forces acting during operation. The legs of said clip are thereby guided through two adjacent gaps in the laminated rotor core, so that the clip protrudes from an interior of the rotor winding overhang to a radial exterior of the rotor winding overhang.

Depending on the specific requirements for an electric machine, in particular a number of pole pairs, a diameter, and a length of the rotor winding overhang, as well as dimensions of the top bars and the bottom bars, and angles at which the top bars are positioned to the bottom bars in the region of the winding overhang, can vary. It has been shown that, with the design proposed in document U.S. Pat. No. 5,606,212, impermissibly high mechanical loads act on the retaining body, the clips, and/or the bottom bars in the case of some rotors. Especially in the case of rotors in which gaps in the winding overhang are close together, the design known from document U.S. Pat. No. 5,606,212 results in particularly narrow and therefore heavily stressed ring disks, which ring disks could already be subject to permissible mechanical limits being exceeded due to variations caused by manufacturing tolerances.

This is addressed by the invention. The object of the invention is to specify a rotor of the type named at the outset in which a stabilization of the winding overhang is possible in a robust manner even in the case of gaps in the winding overhang that are especially close together.

According to the invention, this object is attained by a rotor of the type named at the outset in which the legs protrude through two gaps that are adjacent to different top bars.

The inventors have found that, in a corresponding embodiment, a retaining body, which is typically embodied as a peripheral ring, with a larger cross section can be used, and that mechanical loads can thereby be reduced. In apparatuses from the prior art, for example, legs of the clips always protrude between directly adjacent gaps, which thus border the same top bar, so that a clip only ever grips one top bar.

In the rotor embodiment according to the invention, the legs thus protrude through two gaps that are typically spaced apart from one another by at least one other gap, and the clip therefore normally grips at least two top bars. As a result, a larger spacing between the legs is obtained, which legs typically grip the retaining body inside the winding overhang and are connected to said retaining body in a form tit in a radial direction.

The legs of the clips typically extend solely in a radial direction. The crosspiece, which preferably connects the clips on the radial outside of the rotor winding overhang, typically extends roughly parallel to an axial direction, or parallel to the rotor axis. Accordingly, an axial extension of the retaining body, or of a retaining ring, typically essentially corresponds to an axial extension of the crosspiece.

Here, the terms axial direction, radial direction, and circumferential direction are to be understood in the sense of a cylindrical coordinate system, wherein the axial direction coincides with a rotor axis, or is parallel to said rotor axis, about which the rotor is rotatably arranged in a stator when used as intended.

In this case, crossing points denote points at which a top bar and a bottom bar cross in the region of the winding overhang in a plan view, or with a line of sight along the radial direction, wherein the top bar is arranged at a greater radial distance from the rotor axis than the bottom bar. Here, gaps denote positions at which, with a corresponding line of sight, neither a bottom bar nor a top bar is arranged, so that an unimpeded passage of a clip from an interior of the rotor winding overhang to an exterior of the rotor winding overhang along the radial direction is enabled.

In a corresponding embodiment, the crosspiece thus normally spans at least two crossing points, so that at least two top bars and two bottom bars are normally kinematically coupled with, or are connected in a form fit and/or force fit to, the support device in a radial direction by a clip.

As a result of a correspondingly enlarged cross section of the retaining body, the design according to the invention can also be used in rotors in which gaps in the rotor winding overhang are very close together, for example because the top bars and bottom bars are embodied to be very narrow and/or the top bars and bottom bars cross at an angle of nearly 90°, especially since a length of the crosspiece, and thus an axial extension of the retaining body, is not defined by a spacing between two adjacent gaps; rather, the axial extension of the retaining body can also be a multiple of a spacing between two adjacent gaps.

In addition, a surface pressure of the top bars and the bottom bars is reduced.

Furthermore, a corresponding rotor can be produced with a reduced number of clips, especially since one clip can grip and stabilize multiple top bars and bottom bars in a corresponding embodiment.

The retaining body preferably has an axial extension that corresponds to a multiple of, in particular two times, a spacing between two gaps of the rotor winding overhang, which gaps are located in the same circumferential position along a circumferential direction, that is, are only axially spaced apart from one another. With a retaining body dimension of such a size, variations caused by manufacturing tolerances also have less of an effect on mechanical stresses in the retaining body, so that an easy manufacturability is ensured.

In principle, the clip can be installed in any desired manner in order to connect the retaining body to the top bar, so that the winding overhang is supported, and therefore radially stabilized, on the retaining body by the clip in the corresponding region. Thus, the crosspiece could, in principle, also be arranged on the radial inside in the rotor winding overhang, where it could be connected to the retaining body.

Preferably, however, it is provided that the crosspiece is arranged radially outside the top bars and is connected to at least two top bars. As a result, a simple and simultaneously robust structure is obtained in a region between the rotor winding overhang and stator winding overhang.

The crosspiece can, of course, also grip more than two top bars, for example three or four top bars.

Furthermore, the clip can, in principle, be connected to the retaining body in any desired manner, for example screwed into the retaining body or the like.

However, it is preferably provided that the retaining body is embodied to be ring-shaped, and that the legs protrude up to an inner diameter of the retaining body, in particular in order to reduce pressure peaks. A radial force transferred into an interior of the winding overhang via the clip is then preferably applied to the retaining body via the inner diameter of the retaining body or an inner cylinder surface.

Preferably, a closing link releasably connected to the legs is provided. With said closing link, the clip can be fixed in place on the retaining body and the winding overhang.

Typically, the retaining body is connected to the clip via the closing link. The clip preferably bears against the retaining body on the radial inside, so that centrifugal forces transferred to the legs from the crosspiece, which forces act on the rotor winding overhang and are absorbed by the clip, are transferred via the closing link to an inner diameter of the retaining body, which is preferably embodied to be ring-shaped, typically via a surface contact, in order to avoid pressure peaks.

Thus, a radial force is normally transferred from the top bars to the crosspiece, from the crosspiece to the legs, from the legs to the closing link, and, finally, from the closing link to the retaining body, typically at an inner diameter of the retaining body.

It has proven effective that the closing link comprises radial through-bores through which the legs protrude, wherein securing elements, in particular nuts, are provided the legs after the closing link, which securing elements keep the closing link on the legs. A simple assembly is thereby ensured. With a predefinable tightening torque of the nuts, a defined pretension can be introduced into the legs, so that the rotor winding overhang can be pressed against the retaining body by a predefinable force.

Specifically in order to equalize effects of a settling and/or a creep in the region of the clip, it is preferably provided that, between the securing elements and the closing link, spring elements, in particular disk springs or helical disk springs, are arranged which are preferably pretensioned with a predefined pretension force. Settling effects occurring during operation over a long period can thus be easily compensated, so that a predefined pretension can also be maintained over a long period of time. A manual re-tensioning of the nuts after a break-in phase is therefore no longer required. At the same time, undesirably high pretensions in the legs during the break-in phase are avoided.

The spring elements can be formed by a serial and/or parallel combination of individual springs, in particular individual disk springs.

Furthermore, the spring elements can also be embodied as helical springs made of flat wire that are screwed into one another, which are referred to as helical disk springs. Compared to a disk spring stack, a longer service life is thereby achieved. There also results, compared to a disk spring stack, a simplified assembly, especially since characteristics corresponding to multiple disk springs or to a disk spring stack can be obtained through the use of a helical disk spring with an appropriate length, so that a number of components is reduced.

Typically, the spring elements are brought to a predefined pretension during assembly, in order to be able to compensate settling effects via a corresponding relaxation of the spring elements during operation. A defined pretension can, for example, be achieved by a sleeve or a steel sleeve which is arranged parallel to a disk spring stack or in a helical disk spring, in particular arranged in the disk spring stack or the helical disk spring, and serves as a stop for a nut, with which nut the disk springs or the helical disk spring are tensioned. The nut can thus only be tightened up to a position defined by a position of the stop or a length of the sleeve, whereby a maximum deformation and therefore a pretension of the spring element can be clearly defined.

A defined pretension can thus be obtained in particular without the use of a hydraulic clamping cylinder, for which sufficient space is also often not available.

It is particularly preferred if the pretension is chosen such that the rotor winding overhang, that is, the top bars and bottom bars, only lift off of the retaining body above a rated speed. Thus, even in the case of relatively numerous start/stop cycles, a small tension amplitude in a region of threads of the clips is achieved, via which threads the nuts are connected to the clips. In the event of a failure, the machine can switch to a load shedding speed or runaway speed past the rated speed. In these cases, the stop acts as an overload protection for the spring.

In addition, impermissibly large deformations of the winding overhang in the event of particularly high speeds can thus be prevented using the stop.

The legs of the clip are typically subjected to high mechanical loads, especially since the centrifugal forces of the rotor winding overhang act thereon. It has therefore proven effective that the legs comprise threads that are preferably formed by thread rolling. As a result, the securing elements, which can in particular be embodied as nuts, can be arranged on the clip in a robust manner.

It has proven effective that the clip is formed from an austenitic material, in particular from an austenitic steel. On the one hand, this is beneficial due to the magnetic field that prevails in the rotor winding overhang. On the other hand, an austenitic material has also proven to be very advantageous in terms of mechanical properties for a corresponding application.

In order to be able to ensure a robust support of the rotor winding overhang even at high speeds, it is preferably provided that the clip is formed from a cold-worked metal, in particular a cold-drawn steel.

Advantageously, it is provided that the retaining body comprises a ferritic material, in particular a ferritic steel, or is formed from such a material. As a result, mechanical requirements can be satisfied in a particularly reliable manner.

It is particularly preferred if, for this purpose, it is provided that the retaining body comprises a fine-grain steel, in particular S460, or a quenched and tempered fine-grain steel, in particular S550Q.

In order to ensure particularly low magnetic losses in the winding overhang region, it is preferably provided that the retaining body comprises a ferritic inner portion and a non-magnetic outer portion that is in particular composed of aluminum, a composite fiber material, or a laminated fabric, for example epoxy glass cloth laminate (EPGC). The retaining body can, for example, comprise a ferritic inner ring and a non-magnetic outer ring that can be composed, for example, of aluminum, a composite fiber material, or a laminated fabric, for example EPGC. The inner ring and outer ring can also be movable relative to one another. In this case, the outer ring can be coupled with the bottom bars in an axial direction and the inner ring can be coupled with the laminated core in a fixed manner in an axial direction. It can thereby also be provided that a contact surface between the inner ring and outer ring is formed from a material with particularly low friction coefficients, in order to minimize wear.

A particularly robust design is achieved if the retaining body is connected to the laminated core in a fixed manner in an axial direction. For this purpose, the retaining body can be connected to a pressure plate by screws, for example, which pressure plate is in turn connected to the laminated core in a fixed manner.

In order to prevent centrifugal forces that act on the winding overhang from leading to an additional mechanical loading of the laminated core, it is preferably provided that the retaining body is connected to the laminated core such that it can be moved in a radial direction, in particular by means of a radial guide. It is thus ensured that centrifugal forces in the winding overhang region only result in a deformation of the winding overhang and of the retaining body, but not in a radial deformation of the laminated core, especially since the retaining body is then decoupled from the laminated core in the radial direction. The guide can, for example, comprise slots in the retaining body or in the pressure plate and corresponding guide pins in the pressure plate or in the retaining body.

It is preferably provided that a component, in particular a pressure plate, connected in a fixed manner to the laminated rotor core, comprises first guide means running in a radial direction, in particular radial slots, and the retaining body comprises corresponding second guide means, in particular guide pins, which engage with the first guide means, so that, via the interacting guide means, the retaining body is connected to the laminated core such that it can be moved in a radial direction and is fixed in a circumferential direction.

Depending on the dimensions of the rotor winding overhang, a single, normally peripheral, retaining body can, in principle, already be sufficient, which retaining body is typically coupled with the rotor winding overhang in a radial direction via clips arranged in a distributed manner over a circumference. It is preferably provided, especially in the case of very large winding overhangs, that, in an axial direction multiple, in particular three, retaining bodies are provided which are kinematically coupled in a circumferential direction via radial guide means and can be moved relative to one another in a radial direction, wherein the radial guide means are preferably formed by radial slots and corresponding guide pins that engage with the radial slots. The individual retaining bodies can thus be supported on one another and on the laminated rotor core in an axial direction and in a circumferential direction and they can still be moved relative to one another in a radial direction. This is advantageous in particular because the rotor winding overhang can have a greater radial deformation at an axial end than in a region close to the laminated core.

For a robust axial connection of the retaining bodies to the laminated rotor core, it has proven effective that the retaining bodies are axially connected to the pressure plate by screws, wherein the screws extend continuously from an axially outermost retaining body to the pressure plate, and are in particular under a defined pretension. In order to nevertheless ensure a radial mobility between the individual retaining bodies, the screws can, for example, be guided through bores in the retaining bodies, which bores are larger than the screws.

Electric machines with laminated rotor cores are often produced such that the laminated rotor core is shrink-fitted onto a rotor body, wherein openings extending in an axial direction from an interior can be provided on the rotor body for a ventilation of the laminated rotor core. The shrink-fitting of the laminated rotor core thus results in a deformation of the laminated rotor core which corresponds to the openings and arms onto which the laminated rotor core is shrink-fitted. In order to nevertheless ensure a particularly reliable guidance of the retaining body in a radial direction even when the rotor is formed using a shrink fit, and to avoid a movement of the retaining body relative to the laminated rotor core in a circumferential direction, a design has proven effective in which the rotor comprises a rotor body having arms arranged in a distributed manner over a circumferential direction and openings arranged between the arms, through which openings a cooling air can be supplied to the laminated rotor core, wherein the laminated core is shrink-fitted onto the rotor body, wherein the first guide means, which extend radially, are arranged along a circumferential direction at positions that correspond to positions of the arms in the region of a pressure plate and/or to positions located centrally between the arms in the region of the pressure plate. Thus, the pressure plate and also the laminated rotor core are only radially deformed at these positions during the shrink-fitting, and a region-wise torsion does not occur in these regions, whereby the guides would be bent and a proper functioning of the same would no longer be ensured in all operating conditions. These positions located centrally on the arms and centrally between the arms can therefore also be denoted as torsion-free regions.

Typically, the bars are oriented roughly parallel to the axial direction. Furthermore, the legs of the clips are typically oriented roughly in a radial direction. As a result, the legs are essentially loaded only by tension and, in particular, a bending and torsion load of the legs is essentially avoided.

Depending on a size of the winding overhang, it can be provided that multiple clips are arranged in a distributed manner along a circumferential direction. The clips are positioned over an entire circumference of the rotor winding overhang such that they are typically distributed at regular intervals in a circumferential direction.

Additionally, depending on the size of the winding overhang, it can be beneficial if multiple clips are provided in an axial direction. Thus, clips are preferably arranged in a distributed manner over the rotor winding overhang both in a circumferential direction and in an axial direction, in order to uniformly stabilize the rotor winding overhang at multiple positions by means of the inner retaining body.

Typically, it is provided that the retaining body encompasses the rotor axis and, in particular, is embodied to be plate-shaped, preferably ring-shaped, particularly preferably as a ring disk. Centrifugal forces acting on the retaining body can then be absorbed particularly well, so that a good stabilization of the winding overhang results.

As stated, it can be beneficial if the legs of the clip are under a pretension so that the retaining body is pressed against one or more bottom bars of the rotor winding overhang. During operation, the top bars and bottom bars of the rotor winding overhang become warm, which bars are normally composed of copper or comprise copper and therefore also expand in an axial direction. The retaining body can, as stated, be connected to the laminated core such that it is axially fixed, in particular via screws, and can be subject to an expansion in an axial direction that differs from the winding overhang, that is in particular smaller. In order to avoid damage in the case of a relative movement between the retaining body and the bottom bars in an axial direction as well as thermal stresses, it is preferably provided that, between the retaining body and the bottom bars, a sliding device is arranged which comprises on at least one side a surface that is formed by a material with a low friction coefficient, in particular by a Teflon-carbon plate. The sliding device is advantageously also embodied as a component that encompasses the rotor axis.

Advantageously, the sliding device is connected to the bottom bars in a fixed manner and to the retaining body in an axially movable manner. The sliding device thus normally slides on the retaining body, or a component connected in a fixed manner thereto, with the surface that is formed by a material with a low friction coefficient.

The sliding device preferably comprises an anti-friction layer which is formed from a material with a low friction coefficient, in particular by a Teflon-carbon plate with a radial height of 1 mm to 20 mm, in particular 2 mm to 10 mm.

Furthermore, it can be beneficial if the sliding device comprises a layer which is formed by a paramagnetic material, in particular by aluminum or an epoxy glass cloth laminate, wherein bores running through the layer in an axial direction are preferably provided. With the bores, a ventilation of the rotor winding overhang can thus also be improved in this region. The layer typically extends completely around the rotor axis in the circumferential direction and thus separates the retaining body, which can be composed of a ferromagnetic material or can comprise such a material, from the bottom bars over an entire circumference.

To avoid leakage currents, it can be beneficial if the sliding device comprises a metallic layer which is separated from the bottom bars by an insulating layer connected in a fixed manner to the metallic layer, wherein the insulating layer comprises in particular epoxy glass cloth laminate.

As a result of this insulating layer, the sliding device can also be supported on the bottom bars.

Additional features, advantages, and effects of the invention follow from the exemplary embodiments described below. In the drawings which are thereby referenced:

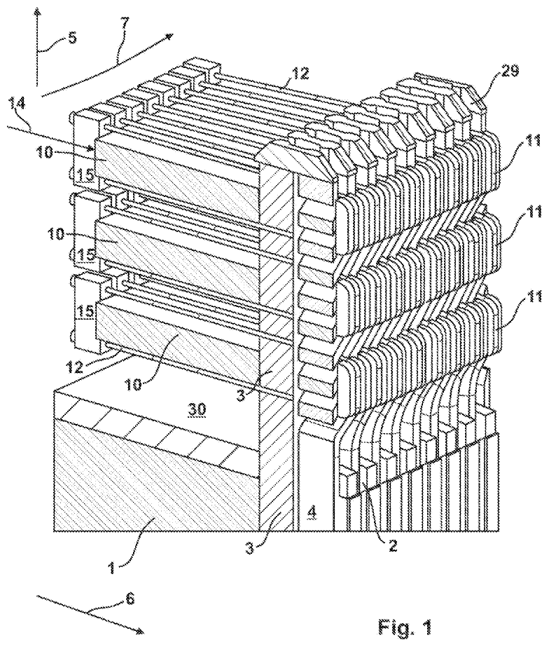

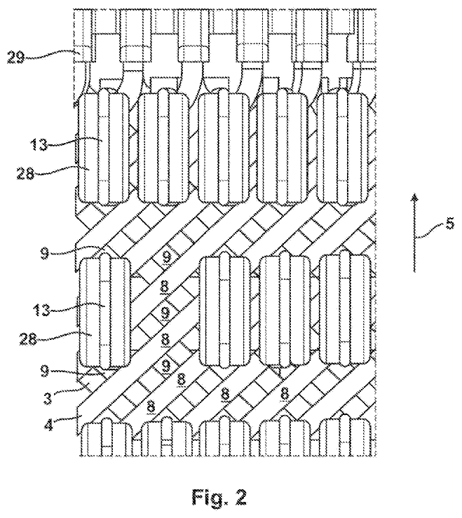

FIGS. 1 and 2 show details of a rotor according to the invention;

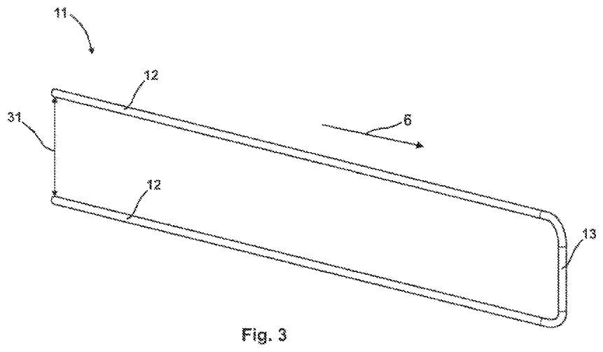

FIG. 3 shows a clip;

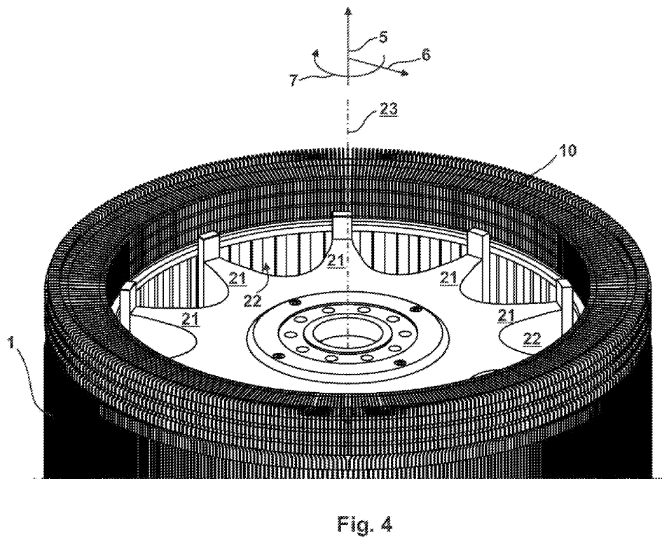

FIG. 4 shows a portion of a rotor;

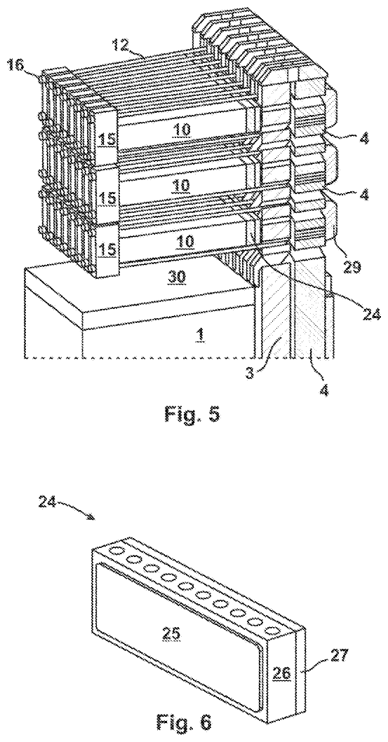

FIG. 5 shows a further detail of a rotor;

FIG. 6 shows a detail of a sliding device;

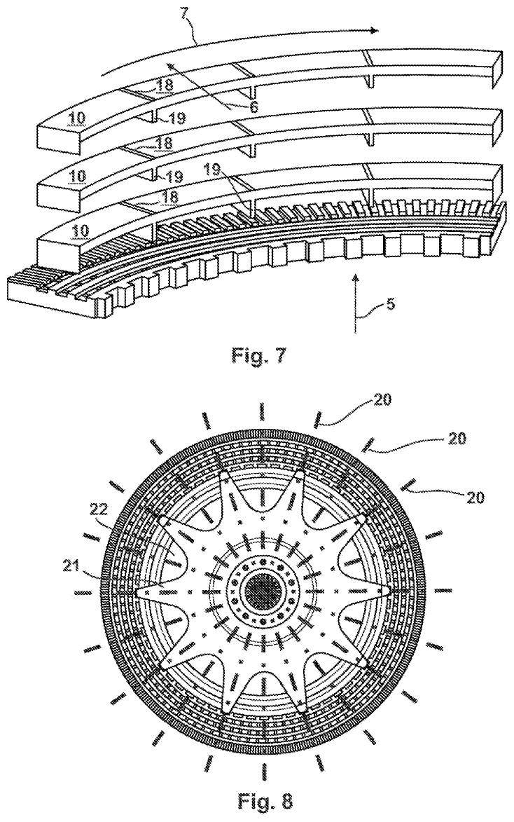

FIG. 7 shows a further detail of a rotor in an exploded illustration;

FIG. 8 shows a plan view of a rotor,

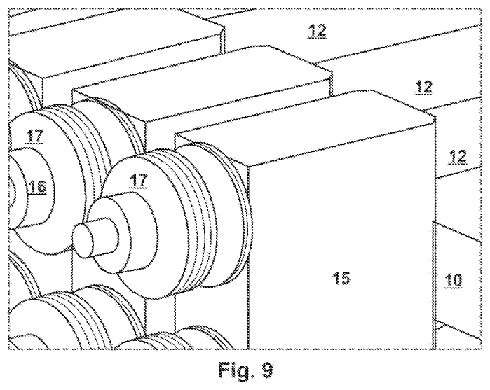

FIG. 9 shows a detail of a further rotor;

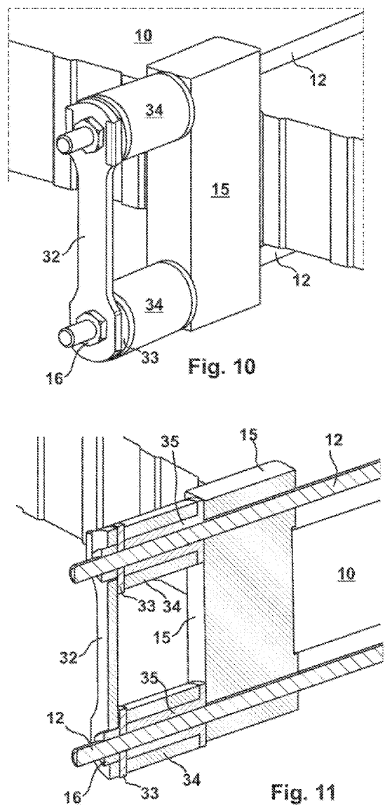

FIGS. 10 and 11 show a detail of a further rotor.

FIGS. 1 through 3 show a region of a winding overhang of a rotor according to the invention, wherein a portion of a laminated core 1 together with a pressure plate 30 arranged at an end of the laminated core 1 is also illustrated. As can be seen, the rotor comprises top bars 4 and bottom bars 3 which are arranged in slots 2 in the laminated core 1 and are connected outside the laminated core 1, wherein as is common for machines of this type, which can be embodied as asynchronous machines, a bottom bar 3 of one slot 2 is always connected to a top bar 4 of another slot 2, in this case by bar connectors 29 arranged at an axial end of the top bars 4 and bottom bars 3.

Whereas the top bars 4 and bottom bars 3 only extend in an axial direction 5 in the laminated core region in this case, top bars 4 and bottom bars 3 axially outside the laminated core 1, or in the winding overhang region, also extend along a circumferential direction 7, in order to produce a connection between a top bar 4 and a bottom bar 3 of two slots 2 spaced apart in the circumferential direction 7. In the exemplary embodiment illustrated, the top bars 4 extend in the circumferential direction 7 at an angle of approximately 45° to the rotor axis 23 or to the axial direction 5, which is parallel to the rotor axis 23, whereas the bottom bars 3 extend in the circumferential direction 7 in a roughly opposite manner at an angle of approximately −45° to the rotor axis 23.

As can be seen in FIG. 2, the top bars 4 therefore cross the bottom bars 3 at an angle of approximately 90° at crossing points 8. Gaps 9 remain between the crossing points 8 in the plan view illustrated in FIG. 2, or in a line of sight in the radial direction 6. Through some of these gaps 9, legs 12 of clips 11 protrude, which clips 11 radially support the winding overhang in that a crosspiece 13 connecting the legs 12 of the clips 11 respectively spans on the outer side two top bars 4, as depicted, and thus radially couples said bars with a retaining body 10 arranged inside the winding overhang. In FIG. 2, one of these clips 11 together with a spacer piece 28 is hidden, so that it is possible to see that the individual clips 11 each overlap two top bars 4 and two bottom bars 3 as well as a gap 9 arranged between said bars.

For a radial support of the clips 11, a closing link 15 is provided on the legs 12 of each clip 11 on the radial inside in the winding overhang, which closing link 15 comprises two through-bores through which the legs 12 protrude and which closing link 15 bears against an inner diameter 14 of the retaining body 10 embodied to be ring-shaped in this case, in order to mechanically couple the retaining body 10 with the top bars 4 via the closing link 15 and the clip 11. The closing link 15 is secured on the legs 12 by nuts 16.

The crosspieces 13 are mechanically coupled with the top bars 4, which said crosspieces 13 span, in this case indirectly via a spacer piece 28 that is used to avoid pressure peaks on the top bars 4. As a result, a radial rigidity of the winding overhang is increased by the clips 11, which connect the ring-shaped retaining bodies 10 to the top bars 4, and indirectly also to the bottom bars 3 via the top bars 4, which is why the clips 11 together with the retaining bodies 10 in this case form support devices for the winding overhang.

In the exemplary embodiment illustrated, three retaining bodies 10 are arranged in an axial direction 5 and, accordingly, three rows of clips 11 are also provided along the axial direction 5, wherein each row comprises clips 11 arranged in a distributed manner over a circumferential direction 7. Here, the crosspieces 13 of the clips 11 extend in an axial direction 5. As illustrated, the crosspieces 13 each span two top bars 4 in this case, so that the legs 12 of the clips 11 are arranged in gaps 9 which are adjacent to different top bars 4. Of course, the clips 11 can also span more than two top bars 4 and more than one gap 9.

As a result, a large leg spacing 31 between the legs 12 of the clips 11 is obtained despite the crossing angle of the top bars 4 and bottom bars 3 of approximately 90°, which in this case, in combination with relatively narrow top bars 4 and bottom bars 3, results in a small axial spacing of the gaps 9. Said leg spacing 31 thus corresponds to at least twice the spacing of two axially adjacent gaps 9.

In this case, the legs 12 extend, as illustrated, solely in a radial direction 6 in order to achieve an essentially solely tensile loading of the legs 12. The retaining body 10 is respectively arranged between two legs 12 of a clip 11, which is why a correspondingly large retaining body 10 that can absorb corresponding forces is achieved by a large leg spacing 31.

The three retaining bodies 10 arranged at different axial positions are in this case embodied as peripheral rings and can thus prevent an impermissible deformation of the rotor winding overhang through the coupling via the clips 11, or can absorb centrifugal forces that arise. For this purpose, the legs 12 of the clips 11 are coupled with the retaining bodies 10 on the radial inside via a closing link 15.

Here, the terms axial direction 5, radial direction 6, and circumferential direction 7 are to be understood in the sense of a cylindrical coordinate system, wherein the axial direction 5 coincides with a rotor axis 23, or is parallel to said rotor axis 23, about which the rotor is rotatably arranged in a stator when used as intended. Accordingly, the circumferential direction 7 corresponds to a rotation direction along which the rotor rotates in the stator when used as intended.

FIG. 3 shows a clip 11 of a corresponding support device in detail, which clip 11 is embodied to be U-shaped in this case. As can be seen, the clip 11 comprises two roughly parallel legs 12 which are connected by a crosspiece 13 that is oriented perpendicularly to the legs 12. At the end of the legs 12, threads are typically arranged so that the closing link 15 can be attached to the clip 11 by means of two nuts 16. The threads are preferably produced by thread rolling or thread rollers in order to also ensure a high strength in the thread region. The clip 11 is normally formed by an austenitic, cold-drawn steel, whereby magnetically favorable properties for an application in the winding overhang region and simultaneously a high strength are obtained.

Between the legs 12 of the winding overhang, the retaining body 10, typically preferably embodied to be ring-shaped, is arranged inside the winding overhang, which is why an axial extension of the retaining body 10 not illustrated in FIG. 3, which can be embodied as a retaining ring for example, or a cross section of the same can be defined by a leg spacing 31. If a corresponding rotor is embodied according to the invention, a comparatively large leg spacing 31 is achieved even with gaps 9 closely adjacent to one another, especially since the legs 12 protrude through gaps 9 which are adjacent to different top bars 4 and bottom bars 3 so that, between the gaps 9 through which the legs 12 protrude, at least one other gap 9 that is spanned by the crosspiece 13 is normally arranged.

FIG. 4 shows a rotor in an isometric view. As can be seen, the rotor comprises a rotor body with arms 21 arranged in a distributed manner about a rotor axis 23, between which arms 21 openings 22 are positioned. Via these openings 22, air can be transported to an inner radius of the laminated core in order to ventilate or cool said laminated core. The laminated core 1 is shrink-fitted onto the arms 21 of the rotor body, in order to form a stable connection between the laminated core 1 and the rotor body.

FIG. 5 shows a detail of a rotor in a further view. The retaining bodies 10 are typically connected to the laminated rotor core in an essentially fixed manner in an axial direction 5 by screws that are not illustrated. During operation, bottom bars 3 and top bars 4 are subjected to a warming and therefore to a thermal expansion, which causes a relative movement in an axial direction 5 between bottom bars 3 and top bars 4 on the one hand and the retaining bodies 10 on the other hand. In order to prevent this relative movement from causing damage, in particular to an insulation of the bottom bars 3, sliding devices 24 are arranged between the retaining bodies 10 and the bottom bars 3.

FIG. 6 shows a detail of a sliding device 24 of this type, which can be connected to the bottom bars 3 in a fixed manner. The sliding device 24 comprises on the radial inside a surface which is formed by a material with a low friction coefficient, typically by a Teflon-carbon plate 25 that can bear against the retaining body 10. This Teflon-carbon plate 25 thus enables a low-friction relative movement between the bottom bars 3, with which the sliding device 24 is typically coupled in an axial direction 5, and the correspondingly adjacent retaining body 10.

The retaining bodies 10 typically comprise a magnetic material or can be composed of a fine-grain steel or the like. In order to minimize magnetic losses in the winding overhang region, it is preferably provided that the sliding device 24 comprises a layer 26 which is formed by a paramagnetic material, in particular by aluminum or epoxy glass cloth laminate. With this layer 26, a spacing between the magnetic retaining body 10, or a magnetic portion of the retaining body 10, and the bottom bars 3 is thus ensured. In order to avoid leakage currents, an insulating layer 27, which can be composed of epoxy glass cloth laminate for example, is arranged on the outside of the sliding device 24. If the layer 26 is composed of an insulating material, the insulating layer 27 can also be embodied in one piece with the layer 26, and can be composed of epoxy glass cloth laminate, for example.

The fine-grain steel can thus form an inner ring of the retaining body 10, whereas the layer 26 of aluminum, or the sliding device, can form an outer ring, wherein the outer ring ensures a spacing between the bottom bars 3 and the inner ring and simultaneously connects the inner ring to the bottom bars 3 in a radial direction.

FIG. 7 shows in an exploded illustration a cutout from three retaining bodies 10, as well as a portion of the laminated core 1. The retaining bodies 10 each comprise guide pins 19 and radial slots 18, which respectively extend along the radial direction 6, so that radial guides are present and the individual retaining bodies 10 can be moved radially relative to one another due to the radial guides, but are kinematically coupled with one another in the circumferential direction 7. Corresponding radial slots 18 are also provided on the pressure plate 30, which is not illustrated here, so that the retaining bodies 10 can also be moved radially relative to the pressure plate 30, but are connected to the pressure plate 30 in a form fit in the circumferential direction 7. In the axial direction 5, the retaining bodies 10 are, as stated, typically coupled with the laminated core 1 in a fixed manner by screws, which are not illustrated, wherein said screws can extend from the pressure plate 30 to an axially outermost retaining body 10.

FIG. 8 shows a plan view of the rotor, wherein torsion-free regions 20 of the rotor are schematically indicated by dash-dotted lines along which the radial guide devices, typically radial slots 18 and corresponding guide pins 19, are arranged. These torsion-free regions 20 of the laminated core 1 and of the pressure plate 30 are thereby arranged at positions located centrally on the arms 21 of the rotor body and centrally between said arms 21. Through an arrangement of the radial guides, which can be formed by slots 2 and corresponding guide pins 19 or the like, a torsion of the guides in a partial opening and closing of the shrink fit during operation is easily avoided, especially since the laminated rotor core and the pressure plate 30 of the rotor are only radially deformed in these regions.

FIG. 9 shows a detail of a further exemplary embodiment, wherein a radial inner end of support devices is illustrated. Here, a closing link 15 is once again also provided on the radial inside of the clip 11, by means of which closing link 15 the clip 11 is closed and coupled with the retaining body 10. Here, too, the legs 12 of the clips 11 are guided through the closing link 15 and nuts 16 are screwed onto the legs 12 at the end, in order to fix the closing link 15 in place on the clips 11. Additionally, spring elements embodied here as disk springs 17 are provided between the nuts 16 and the closing links 15, wherein three disk springs 17 each are serially positioned between the nuts 16 and the closing link 15 in this case. Thus, a predefined pretension can be introduced into the legs 12, which pretension can also be maintained via the spring elements in the case of settling processes. As a result, a readjustment of the nuts 16 after a breaking-in of the rotor can be avoided.

FIGS. 10 and 11 show a further exemplary embodiment in detail, wherein a radial inner end of a support device is once again illustrated. Here, too, the legs 12 of the clips 11 are guided through the closing link 15 and nuts 16 are screwed onto the legs 12 at the end, in order to fix the closing link 15 in place on the clips 11. Furthermore, spring elements are also provided here which connect the clips 11 to the closing link 15 via the nuts 16, wherein additional steel washers 33 are arranged between the spring elements and the nuts 16 in this case. FIG. 10 thereby shows the detail in an isometric view, whereas FIG. 11 shows a section view.

As can be seen in FIG. 11, the spring elements, which are embodied here as helical disk springs 34, are thereby arranged concentrically with the clips 11, and a sleeve 35 that serves as a stop is respectively arranged parallel to the helical disk springs 34, in this case inside the helical disk springs 34. By means of the sleeve 35, the spring elements can thus easily be pretensioned up to a defined deformation or a defined pretension, with which deformation of the helical disk springs 34 the steel washers 33 respectively bear against the sleeves 35. The pretension chosen thus defines, in combination with the spring elements, dimensions of the sleeves 35 and can be chosen, for example, such that a lifting-off of the winding overhang from the support device is reliably prevented up to a rated speed of the machine, in the case of a speed that exceeds the rated speed, which speed can occur in the event of a failure, for example, the sleeves 35 reliably prevent damage to the spring elements, especially since the sleeves 35 acting as a stop prevent an impermissibly large deformation of the spring elements in that case.

FIGS. 10 and 11 furthermore show an anti-loosening protection 32 for the nuts 16, which is connected to both nuts 16 in a form fit in order to prevent an inadvertent loosening of the nuts 16 during operation. In the exemplary embodiment illustrated, both the anti-loosening protection 32 and the support device are formed from EPGC, although other materials are, of course, also possible.

A rotor according to the invention enables the reinforcement of winding overhangs in corresponding machines in a robust manner even if a spacing between gaps 9 in the winding overhang region is very small due to the design. Such machines can be used in pumped-storage power plants in particular.

1. A rotor for an electric machine, comprising a laminated core with slots in which bottom bars and top bars are arranged, which bars extend in an axial direction beyond the laminated core to form a winding overhang, wherein a bottom bar of one slot is respectively connected to a top bar of another slot in the winding overhang and, in a plan view, bottom bars and top bars cross axially outside the laminated core at crossing points and gaps remain between the crossing points, wherein a support device is provided which has a retaining body arranged radially inside the winding overhang and at least one clip having two legs and a crosspiece, the clip being connected to both the retaining body and to a top bar in order to radially support the top bar by the retaining body, and the retaining body being arranged between the two legs, wherein the crosspiece spans two top bars so that the legs protrude through two gaps that are adjacent to different top bars.

2. The rotor according to claim 1, wherein the crosspiece is arranged radially outside the top bars and is connected to at least two top bars.

3. The rotor according to claim 1, wherein the retaining body is embodied to be ring-shaped and the legs protrude up to an inner diameter of the retaining body.

4. The rotor according to claim 1, wherein a closing link that is releasably connected to the legs is provided.

5. The rotor according to claim 4, wherein the retaining body is connected to the clip via the closing link.

6. The rotor according to claim 4, wherein the closing link comprises radial through-bores through which the legs protrude, wherein securing elements, in particular nuts, are provided on the legs after the closing link, which securing elements keep the closing link on the legs.

7. The rotor according to claim 6, wherein, between the securing elements and the closing link, spring elements, in particular disk springs, are arranged which are preferably pretensioned with a predefined pretension force.

8. The rotor according to claim 1, wherein the legs comprise threads that are preferably formed by thread rolling.

9. The rotor according to claim 1, wherein the clip is formed from an austenitic material.

10. The rotor according to claim 1, wherein the clip is formed from cold-worked metal, in particular a cold-drawn steel.

11. The rotor according to claim 1, wherein the retaining body comprises a ferritic material, in particular a ferritic steel, or is formed from such a material.

12. The rotor according to claim 1, wherein the retaining body comprises a fine-grain steel.

13. The rotor according to claim 1, wherein the retaining body comprises a ferritic inner portion and a non-magnetic outer portion that is in particular composed of aluminum, a composite fiber material, or a laminated fabric, for example epoxy glass cloth laminate.

14. The rotor according to claim 1, wherein the retaining body is connected to the laminated core in a fixed manner in an axial direction.

15. The rotor according to claim 1, wherein the retaining body is connected to the laminated core such that it can be moved in a radial direction, in particular by a radial guide.

16. The rotor according to claim 1, wherein a component, in particular a pressure plate, connected in a fixed manner to the laminated rotor core comprises a first guide running in a radial direction, in particular radial slots, and the retaining body comprises a corresponding second guide, in particular guide pins, which engage with the first guide, so that, via the interacting guides, the retaining body is connected to the laminated core such that it can be moved in a radial direction and is fixed in a circumferential direction.

17. The rotor according to claim 16, wherein, in an axial direction, multiple, in particular three, retaining bodies are provided which are kinematically coupled in a circumferential direction via a radial guide and can be moved relative to one another in a radial direction, wherein the radial guide is preferably formed by radial slots and corresponding guide pins that engage with the radial slots.

18. The rotor according to claim 17, wherein the retaining bodies are axially connected to the pressure plate by screws, wherein the screws extend continuously from an axially outermost retaining body to the pressure plate and are in particular under a defined pretension.

19. The rotor according to claim 16, wherein the rotor comprises a rotor body having arms arranged in a distributed manner along a circumferential direction and openings arranged between the arms, through which openings a cooling air can be supplied to the laminated rotor core, wherein the laminated core tis shrink-fitted onto the rotor body, wherein the first guide, which extend radially, are arranged along a circumferential direction at positions that correspond to positions of the arms in the region of a pressure plate and/or to positions located centrally between the arms in the region of the pressure plate.

20. The rotor according to claim 1, wherein the crosspieces are oriented roughly parallel to the axial direction.

21. The rotor according to claim 1, wherein multiple clips are arranged in a distributed manner along a circumferential direction.

22. The rotor according to claim 1, wherein multiple clips are provided in an axial direction.

23. The rotor according to claim 1, wherein the retaining body encompasses a rotor axis and is in particular embodied to be plate-shaped.

24. The rotor according to claim 1, wherein, between the retaining body and the bottom bars, a sliding device is arranged which comprises on at least one side a surface that is formed by a material with a low friction coefficient, in particular by a Teflon-carbon plate.

25. The rotor according to claim 24, wherein the sliding device is connected to the bottom bars in a fixed manner and to the retaining body in an axially movable manner.

26. The rotor according to claim 24, wherein the sliding device comprises an anti-friction layer which is formed from a material with a low friction coefficient, in particular by a Teflon-carbon plate with a radial height of 1 mm to 20 mm, in particular 2 mm to 10 mm.

27. The rotor according to claim 24, wherein the sliding device comprises a layer which is formed by a paramagnetic material, in particular by aluminum or an epoxy glass cloth laminate, wherein bores running through the layer in an axial direction are preferably provided.

28. The rotor according to claim 24, wherein the sliding device comprises a metallic layer which is separated from the bottom bars by an insulating layer connected in a fixed manner to the metallic layer, wherein the insulating layer comprises in particular epoxy glass cloth laminate.
